(19) United States
(12) Patent Application Publication
(10) Pub. No.: US 2025/0307652 A1
(43) Pub. Date: Oct. 2, 2025

(54) SYSTEM AND METHOD FOR UNIFIED FEDERATED LEARNING FOR TIME SERIES FORECASTING APPLICATIONS

(71) Applicant: Denso International America, Inc., Southfield, MI (US)

(72) Inventors: Yunfei Xu, Milpitas, CA (US); Toru Hirano, Mountain View, CA (US)

(21) Appl. No.: 18/928,798

(22) Filed: Oct. 28, 2024

Related U.S. Application Data
(60) Provisional application No. 63/569,801, filed on Mar. 26, 2024.

(51) Int. Cl. G06N 3/098

(52) U.S. Cl. CPC G06N 3/098

(57) ABSTRACT

Systems and methods for unified federated learning for time series forecasting applications are described herein. In one example, an edge server includes a processor and a memory in communication with the processor. The memory includes instructions that, when executed by the processor, cause the processor to train a model deployed on the edge server using information from one or more external devices received by the edge server and in response to a determination that the training of the model improved performance of the model, deploy the model. In addition, the instructions also cause the processor to, in response to a request from an aggregation server, transmit one or more model parameters of the model to the aggregation server and, in response to receiving an updated model from the aggregation server, deploy the updated model.

### CROSS-REFERENCE TO RELATED APPLICATION

This application claims priority to U.S. Provisional Patent Application No. 63/569,801, filed on Mar. 26, 2024, the contents of which are hereby incorporated by reference in its entirety.

### TECHNICAL FIELD

The subject matter described herein relates, in general, to systems and methods for unified federated learning for time series forecasting applications. As an example, the time series forecasting applications can include smart intersection applications. However, the systems and methods described herein can also apply to other types of time series forecasting applications as well.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Traditional machine-learning approaches often require extensive data collection to train accurate models. In the context of vehicles, this data can include sensitive information such as location history, driving behavior, and even personal preferences. When this data is collected and stored centrally, it becomes vulnerable to unauthorized access, breaches, or misuse. For example, if a machine learning model is trained using detailed global positioning system (GPS) data, it could reveal an individual's daily routines, frequented locations, and other private habits. This not only raises concerns about data security but also about the potential misuse of this information by third parties for purposes like targeted advertising or surveillance.

Additionally, the centralized nature of traditional machine learning often necessitates the transfer of raw data from vehicles to a central server for processing. This data transmission can further expose personal information to interception or hacking during transit. In cases where multiple stakeholders, such as automobile manufacturers, insurers, and service providers, have access to this data, it becomes difficult to ensure strict privacy controls and data governance. Consequently, individuals may lose control over their personal information, making them vulnerable to privacy invasions and diminishing their trust in connected vehicle technologies.

Furthermore, because significant amounts of data are required to train models accurately, traditional approaches typically require substantial amounts of data to be transmitted between vehicles and central servers for training and real-time processing. This data includes high-resolution sensor data, camera feeds, detailed telemetry, and other vehicle diagnostics, all of which can add up to several gigabytes per day for a single vehicle. To transmit this data reliably and quickly, a high-bandwidth network connection is necessary. However, many vehicles, especially those in remote or less-connected areas, may not have access to such bandwidth consistently. This limitation can lead to delays in data transmission, incomplete data uploads, and inefficient model updates, ultimately affecting the performance and reliability of the machine-learning models. Moreover, relying on continuous, high-bandwidth data transfer can also be costly and impractical for vehicle owners, making traditional approaches less feasible for widespread implementation.

### SUMMARY

This section generally summarizes the disclosure and is not a comprehensive explanation of its full scope or all its features.

In one embodiment, an edge server includes a processor and a memory in communication with the processor. The memory includes instructions that, when executed by the processor, cause the processor to train a model deployed on the edge server using information from one or more external devices received by the edge server and in response to a determination that the training of the model improved the performance of the model, deploy the model. In addition, the instructions also cause the processor to, in response to a request from an aggregation server, transmit one or more model parameters of the model to the aggregation server and, in response to receiving an updated model from the aggregation server, deploy the updated model.

In another embodiment, a method includes the steps of training a model deployed on the edge server using information from one or more external devices received by the edge server and, in response to a determination that the training of the model improved the performance of the model, deploying the model. The method also includes the steps of, in response to a request from an aggregation server, transmitting one or more model parameters of the model to the aggregation server and, in response to receiving an updated model from the aggregation server, deploying the updated model.

In yet another embodiment, a non-transitory computer-readable medium includes instructions that, when executed by a processor, cause the processor to train a model deployed on the edge server using information from one or more external devices received by the edge server and in response to a determination that the training of the model improved the performance of the model, deploy the model. In addition, the instructions also cause the processor to, in response to a request from an aggregation server, transmit one or more model parameters of the model to the aggregation server and, in response to receiving an updated model from the aggregation server, deploy the updated model.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a high-level architecture of a system for unified federated learning for time series forecasting applications.

FIG. 2 illustrates one example of the deployment of a system for unified federated learning for time series forecasting applications.

FIG. 3 illustrates one example of an edge server of a system for unified federated learning communicating with external devices.

FIG. 4 illustrates a more detailed view of the edge server.

FIGS. 5 and 6 illustrate methods executed by the edge server.

FIGS. 7 and 8 illustrate different time-series applications related to smart intersections that can utilize the system for unified federated learning.

### DETAILED DESCRIPTION

Described herein are systems and methods for unified federated learning for time series forecasting applications, which may include applications such as smart intersections. Moreover, a unified federated learning system may include an aggregation server and one or more edge servers. The one or more edge servers may be in communication with a number of different external devices that provide information that can be utilized to train one or more models executed by the edge servers. For example, in a smart intersection application, the external devices may be vehicles, traffic controllers, nearby mobile devices, fixed sensors, electronic signs, and the like. Using the information from the external devices, the edge servers may train models that output predicted time series data. If the training of the model improves its performance, the updated model may be deployed. Otherwise, the edge server may continue utilizing a prior version of the model.

In addition, the edge servers may receive a request from the aggregation server. In response, the edge servers may transmit model parameters of the models to the aggregation server, which can then utilize the model parameters to devise an updated model. Once created by the aggregation server, the updated model may then be distributed to the edge servers for use in inference mode. Like before, the edge servers may continuously train the updated model and continue the process of providing the aggregation server, upon request, with the updated model parameters.

As such, the systems and methods described herein result in a unified platform for time series forecasting applications that solve the issues with prior art systems. The unified platform is standardized and may support any category of prediction tasks with many practical prediction applications. In addition, road user data does not leave the edge servers and is therefore protected. Finally, because sensitive data is only transmitted between the edge server and the external devices, there can be a reduction in bandwidth demands.

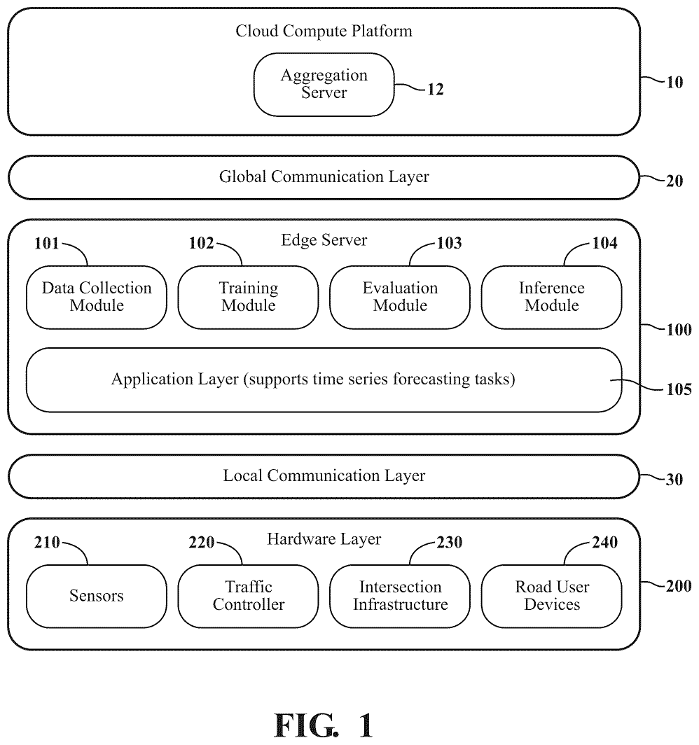

FIG. 1 illustrates one example of a high-level architecture for a unified platform for time series forecasting applications. In this example, the unified platform may include a cloud compute platform 10 that includes at least one aggregation server 12, an edge server 100, and a hardware layer 200. The edge server 100 may communicate with the cloud compute platform 10 utilizing a global communication layer 20. In one example, the global communication layer 20 may be a network infrastructure that enables data exchange and connectivity between the cloud compute platform 10 and the edge server 100. As mentioned before, the edge server 100 may be one of many edge servers that are communicating with the cloud compute platform 10.

The edge server 100 may include a number of different modules, which may include software and/or hardware resources, which allow the edge server 100 to perform a number of different operations. In one example, the edge server 100 may include a data collection module 101, a training module 102, an evaluation module 103, and an inference module 104. In one example, the data collection module 101 enables the edge server 100 to collect data from a number of different external sources, such as the hardware layer 200. The training module 102 enables the edge server 100 to train one or more models, while the evaluation module 103 enables the edge server 100 to evaluate the trained models to determine if their performance has improved. The inference module 104 enables the edge server 100 to execute the models in inference mode. The one or more models utilized by the edge server 100 may generate time series related information that may be utilized by an application layer 105 to provide any one of a number of different services.

The hardware layer 200 can include a number of different external devices that can communicate with the edge server 100. As will be explained in greater detail later, the hardware layer 200 can include sensor(s) 210, one or more traffic controllers 220, intersection infrastructure 230, and/or road user device(s) 240. A description of these components will be described later.

The hardware layer 200 can communicate with the edge server 100 via a local communication layer 30. The local communication layer 30 may be a network infrastructure designed to facilitate fast and efficient data exchange between the hardware layer 200 and the edge server 100. The local communication layer 30 may leverage short-range, high-bandwidth communication technologies like Wi-Fi, the fifth-generation technology standard for cellular network (5G), Long Term Evolution (LTE), cellular-vehicle-to-everything (C-V2X), dedicated short-range communications (DSRC), and the like to ensure low-latency interactions and minimize data transmission delays.

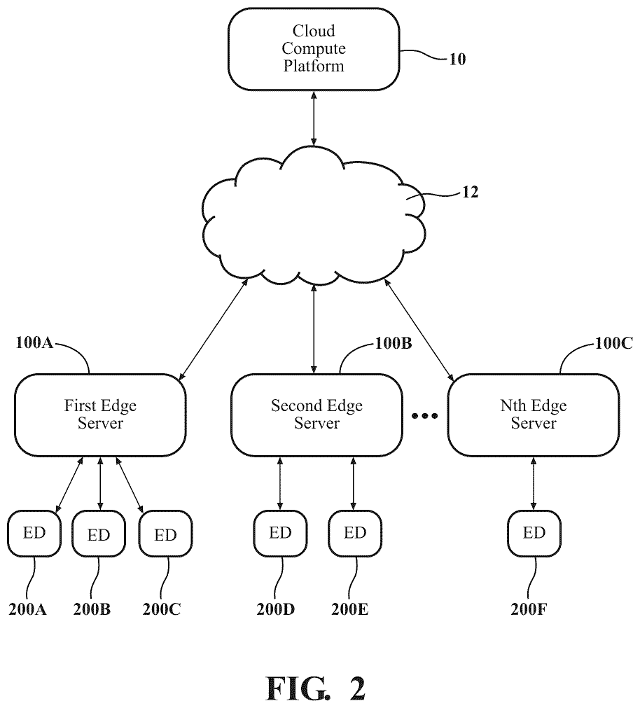

FIG. 2 illustrates an example of a system for unified federated learning for time series applications. In this example, the cloud compute platform 10 is shown to communicate with any number of edge servers 100A-100C. While only three edge servers are shown, it should be understood that the cloud compute platform 10 may communicate with any of a number of different edge servers. Also, in this example, each of the edge servers 100A-100C are shown to communicate with different external devices 200A-200F. In this example, the edge server 100A is communicating with three external devices 200A-200C, the edge server 100B is shown to communicate with two external devices 200D-200E, and the edge server 100C is shown to communicate with only one external device 200F.

As such, in this example, the system for unified federated learning for time series applications can vary significantly depending on the application. In some cases, there may be more or less edge servers. In other cases, there may be more, fewer, or even different types of external devices communicating with the edge servers. For example, in a smart intersection application, one intersection may have a significant number of external devices, such as sensors, while another intersection may have fewer external devices. Regardless of the configuration, the system for unified federated learning for time series applications can function to continuously train models both locally by the edge servers and then aggregate this training in a federated manner using the cloud compute platform 10.

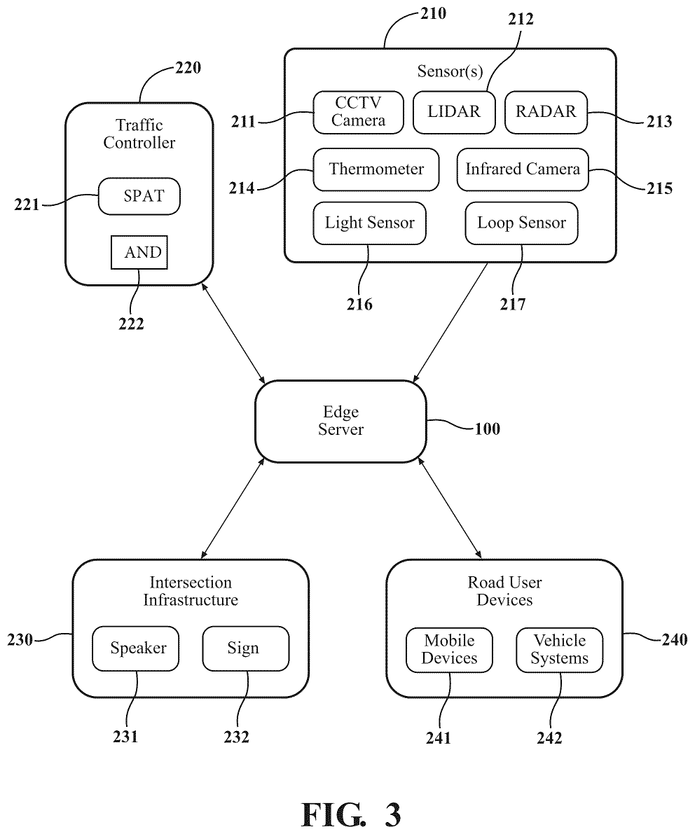

Referring to FIG. 3, illustrated are different examples of the external devices making up the hardware layer 200. As mentioned before, the hardware layer 200 may include sensor(s) 210, one or more traffic controllers 220, intersection infrastructure 230, and/or road user device(s) 240. Again, it should be understood that this is just one example of the types of devices that may make up the hardware layer 200.

The sensor(s) 210 may include any one of a number of different sensors of varying types. In this example, the sensor(s) 210 include a closed-circuit television (CCTV) camera 211, a light detection and ranging (LIDAR) sensor 212, a radar 213, a thermometer 214, an infrared camera 215, a light sensor 216, and/or a loop sensor 217. The sensor(s) 210 may be fixed so as to collect information from a certain vantage point.

The traffic controller 220 may be one or more devices that are utilized to control the flow of vehicle traffic. In one example, the traffic controller 220 may be a traffic light and/or sign that provides information to operators of vehicles. In another example, traffic controller 220 may include a single phase and timing (SPaT) traffic controller 221, which is a system that provides real-time information about the current state and timing of traffic signals at intersections. It communicates data on the status of traffic lights, including which lights are green, yellow, or red, and the duration of each phase. In yet another example, the traffic controller 220 may include an adaptive network design (AND) traffic controller 222, which may be a system that dynamically adjusts traffic signals based on real-time traffic conditions and network demands.

The intersection infrastructure 230 may include infrastructure that communicates to road users using visual and/or audible information. For example, the intersection infrastructure 230 may include one or more speaker(s) 231 and/or sign(s) 232 that can be used to audibly project and/or display information to road users. In particular, the applications forming the application layer 105 executed by the edge server 100 may, from time to time, utilize the intersection infrastructure 230 to communicate with road users.

The road user device(s) 240 may include devices utilized by road users, such as mobile devices 241 and/or one or more vehicle systems 242. Moreover, the mobile devices 241 receive information from the edge server 100, such as messaging information, and provide these messages visually or audibly to a road user. In addition, the mobile devices 241 may be able to provide information, such as sensor-related information collected from one or more sensors of the mobile devices 241 and/or other information provided by the road user device(s) 240 to the edge server 100. For example, the mobile devices 241 may include sensors similar to the sensor(s) 210 previously described.

Similarly, the one or more vehicle systems 242 can receive and/or send information to the edge server 100. As it is well known, the vehicle systems 242 may have access to a number of different vehicle sensors, which may be similar to the sensor(s) 210, and/or other vehicle information, such as vehicle speed, heading, location, etc., to the edge server 100.

Again, it should be understood that the external devices forming the hardware layer 200, such as the traffic controller 220, the sensor(s) 210, the intersection infrastructure 230, and/or the road user device(s) 240, can vary from application to application and may differ from what has been previously described.

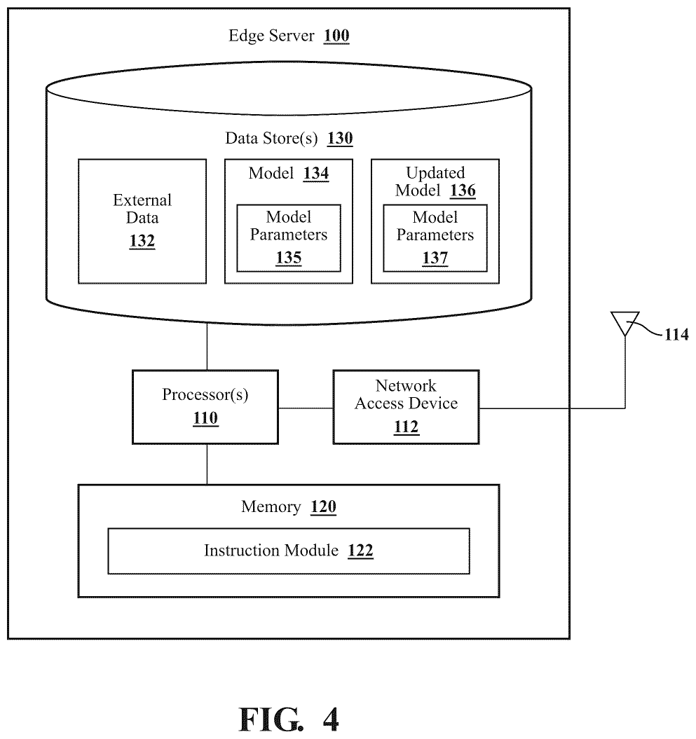

Referring to FIG. 4, illustrated is one example of the edge server 100. Here, the edge server 100 includes one or more processor(s) 110. Accordingly, the processor(s) 110 may be a part of the edge server 100, or the edge server 100 may access the processor(s) 110 through a data bus or another communication path. In one or more embodiments, the processor(s) 110 is an application-specific integrated circuit that is configured to implement functions associated with an instruction module 122. In general, the processor(s) 110 is an electronic processor, such as a microprocessor, which is capable of performing various functions as described herein.

The edge server 100 may also include a network access device 112. The network access device 112 allows the processor(s) 110, and therefore the edge server 100, to communicate with the external devices previously mentioned and the aggregation server 12. As such, the network access device 112 may include both hardware and software components that enable the edge server 100 to connect to and communicate over a network. The hardware aspect may include physical devices such as routers, switches, modems, and access points, which facilitate the connection between the edge server 100 and other devices. On the software side, the network access device 112 may include network management software that controls the hardware, configures network settings, manages user access, and ensures secure communication.

The network access device 112 may communicate with outside devices, such as the external devices previously discussed and/or the aggregation server 12, via a wired or wireless connection. In one example, the network access device 112 may utilize one or more antennas 114 to communicate wirelessly.

Here, the edge server 100 includes a memory 120 that stores instruction module 122. The memory 120 may be a random-access memory (RAM), read-only memory (ROM), a hard disk drive, a flash memory, or other suitable memory for storing the instruction module 122. The instruction module 122 is, for example, computer-readable instructions that, when executed by the processor(s) 110 cause the processor(s) 110 to perform the various functions disclosed herein.

Furthermore, in one example, the edge server 100 includes a data store 130. The data store 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store 130 stores data used by the instruction module 122 in executing various functions.

In this example, the data store 130 may store the external data 132 collected from the external devices forming the hardware layer 200 that was previously described. As such, the external data 132 can include sensor data from either fixed sensors, such as the sensor(s) 210, and/or from the road user device(s) 240. In addition, the external data 132 may include information collected from the traffic controller 220. Of course, depending on the application, the external data 132 may vary considerably. In some examples, the external data 132 may be preprocessed to standardize the format of the external data 132.

The data store 130 may also store one or more models that may generate predicted time series data that may be utilized by the application layer 105. Here, the data store 130 includes a model 134 having model parameters 135, and an updated model 136 with updated model parameters 137. As will be explained throughout this description, the processor(s) 110 of the edge server 100 continuously trains the model 134. Additionally, when requested, the edge server 100 may transmit the model parameters 135 of the model 134 to the aggregation server 12. The aggregation server 12, in turn, collects model parameters from multiple edge servers, where they are combined to create a global model, which is then transmitted back to the edge server 100 as the updated model 136. This updated model 136 can then be utilized instead of the prior model 134. Essentially, the updated model 136 replaces the model 134 to take advantage of the unified federated learning system described herein.

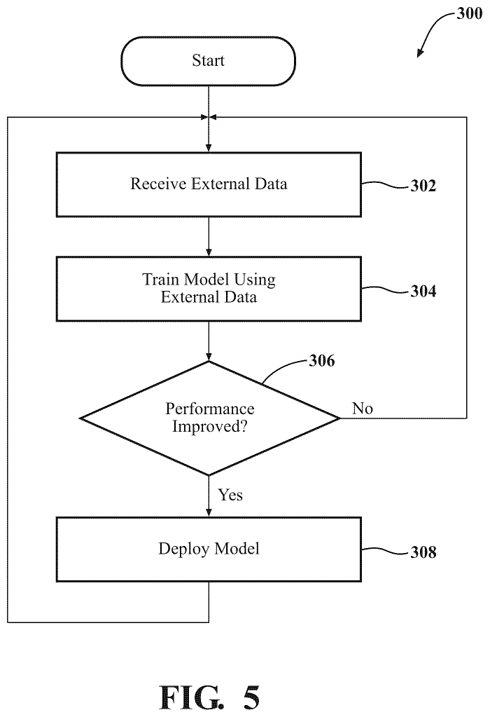

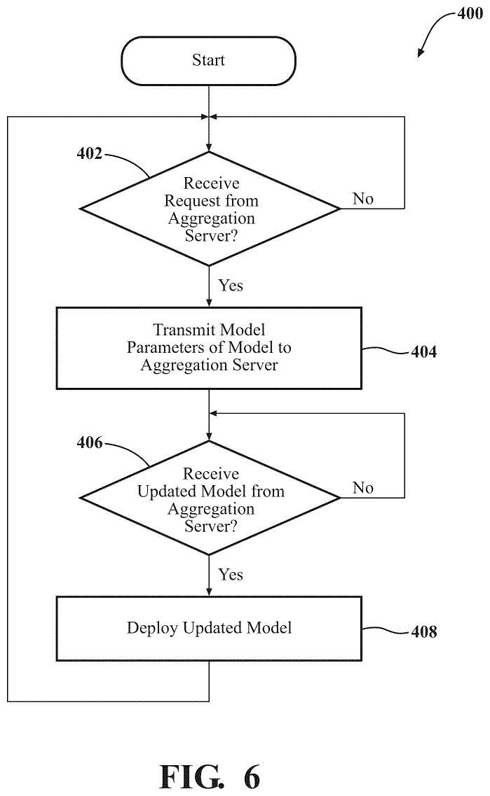

As mentioned before, the instruction module 122 contains instructions that cause the processor(s) 110 to perform any of the methodologies described herein. With reference to FIGS. 5 and 6, illustrated are methods 300 and 400 for unified federated learning for time series forecasting applications. The methods 300 and 400 will be described from the viewpoint of the edge server 100 in FIG. 4. However, it should be understood that this is just one example of implementing the methods 300 and 400. While methods 300 and 400 are discussed in combination with the edge server 100, it should be appreciated that the methods 300 and 400 are not limited to being implemented within the edge server 100, but are instead one example of a system that may implement the methods 300 and 400. As such, the methods 300 and 400 may be embodied within the instruction module 122 as processor-executable instructions that, when executed by the processor(s) 110, cause the processor(s) 110 to perform the methods 300 and 400.

As mentioned before, the unified federated learning system allows the edge server 100 to locally train a model 134 based on the external data 132 received from external devices and, periodically, transmit the model parameters 135 of the model 134 to the aggregation server 12. The aggregation server 12 will then generate a global model based on the model parameters 135 as well as other model parameters sent to it from other edge servers. The method 300 relates to the local training of the model 134, while the method 400 relates to the generation of the global model.

With a focus on the method 300, the method 300 begins at step 302, wherein the instructions stored within the instruction module 122, when executed by the processor(s) 110, cause the processor(s) 110 to receive external data 132. As mentioned before, the external data 132 may be collected from any of the devices forming the hardware layer 200, such as the sensor(s) 210, the traffic controller 220, the intersection infrastructure 230, and/or the road user device(s) 240.

In step 304, the instructions stored within the instruction module 122, when executed by the processor(s) 110, cause the processor(s) 110 to train the model 134 using the external data 132. As mentioned before, the model 134 may generate any one of a number of different predictions, such as time series related predictions. As such, the model 134 may be able to determine traffic flow, vehicle trajectory, pedestrian trajectory, or other road user trajectories. During the training, the model 134 may utilize the external data 132 as an input and output a time series prediction. This time series prediction can then be compared to what actually occurs, as detected by the hardware layer 200. The model parameters 135 of the model 134 can then be adjusted based on the difference between what was predicted and what actually occurred as detected by the hardware layer 200. Over time, the model 134 is trained.

In step 306, the instructions stored within the instruction module 122, when executed by the processor(s) 110, cause the processor(s) 110 to determine if the training of the model 134, as described in the paragraph above, has improve the overall performance of the model 134. If the performance of the model 134 is not improved, the method 300 returns to step 302. Conversely, if it is determined that the training has improved the performance of the model 134, the trained model 134 will be deployed, as indicated in step 308. As such, the method 300 allows the model 134 to be continuously trained and improved over time.

Turning attention to the method 400, the method 400 begins at step 402, wherein the instructions stored within the instruction module 122, when executed by the processor(s) 110, cause the processor(s) 110 to determine if a request is received from the aggregation server 12. If no request is received, the method performs the step 402 again. However, if a request is received, the method proceeds to step 404, wherein the instructions stored within the instruction module 122, when executed by the processor(s) 110, cause the processor(s) 110 to transmit the model parameters 135 of the model 134 to the aggregation server 12.

Upon receiving the model parameters 135, as well as model parameters from other edge servers and/or models, the aggregation server 12 combines these parameters to form a new global model. For example, the aggregation server 12 may utilize Federated Averaging (FedAvg), where the aggregation server 12 averages the parameters, weighted by the number of data points each edge server used for training. This ensures that each edge servers with more data have a proportionally larger influence on the global model. Other methods may involve more sophisticated weighting schemes to account for the reliability or importance of each edge server's data.

In step 406, the instructions stored within the instruction module 122, when executed by the processor(s) 110, cause the processor(s) 110 to determine if the new global model (the updated model 136) has been received from the aggregation server 12. If not, the method 400 returns to step 406 and awaits the updated global model. Otherwise, the method 400 proceeds to step 408, wherein the new global model (the updated model 136) is deployed.

The updated model 136 essentially replaces the model 134. As such, the new global model will receive further training by the edge server 100, as indicated and described by the method 300. This process may be repeated iteratively. This approach allows the global model to benefit from diverse data distributed across all different edge servers while maintaining data privacy and reducing data transmission costs.

As mentioned before, the unified federated learning system described herein can be utilized with a number of different time series related applications, including smart intersection applications. However, again, it should be understood that the applications that the unified federated learning system described herein can be numerous and may not necessarily be described in this disclosure.

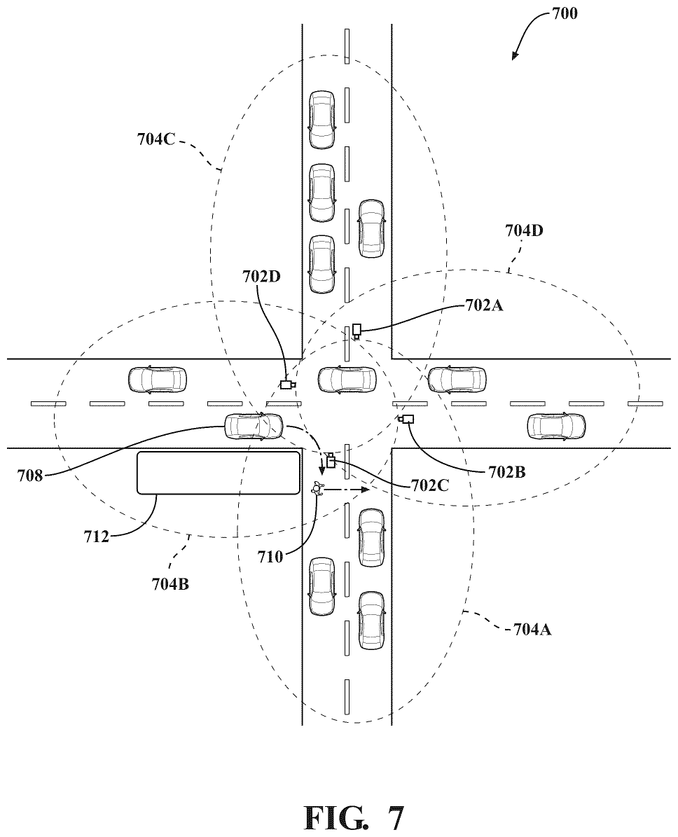

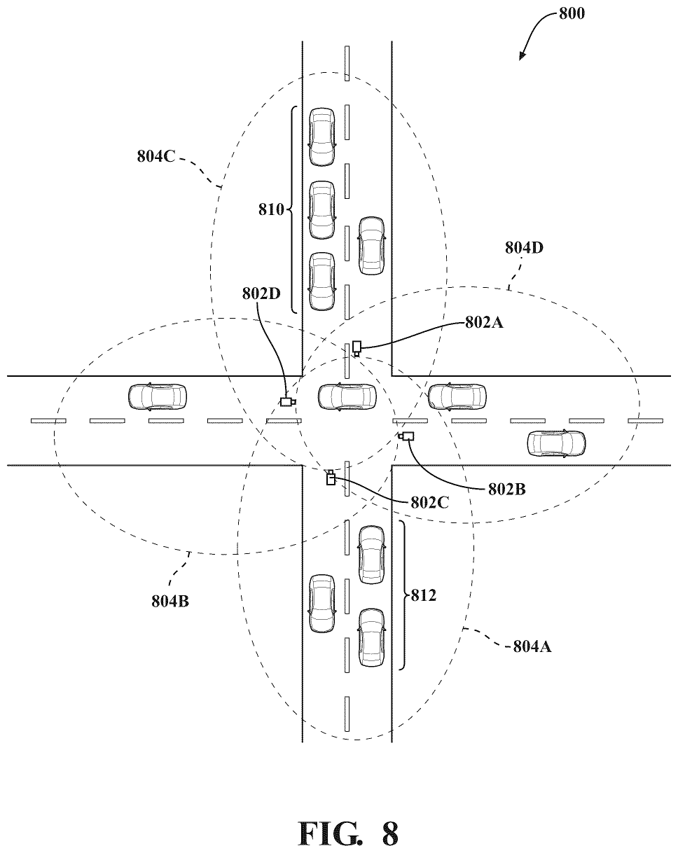

FIGS. 7 and 8 describe two such examples of applications that may benefit from the unified federated learning system described herein. Moreover, FIG. 7 illustrates a smart intersection 700 that includes cameras 702A-702D having fields of view 704A-704D, respectively. The cameras 702A-702D are essentially the external devices previously described and collect information regarding the presence and movement of different road users, such as vehicles and pedestrians. Using this information, the edge server 100 can predict the trajectories of the road users, such as the vehicle 708 and the pedestrian 710. Also shown is a barrier 712 that may block the field of view of the driver the vehicle 708 with respect to the pedestrian 710.

In this situation, the edge server 100 may determine that the trajectories of the vehicle 708 and the pedestrian 710 may collide, resulting in a potential injury to the pedestrian 710. When this occurs, the edge server 100 can communicate to the driver of the vehicle 708 and/or the pedestrian 710 utilizing the hardware layer 200. For example, notification messages may be sent to the vehicle 708 and/or the mobile device held by the pedestrian 710. Further still, notification messages may be sent to a sign that can relay the danger to the pedestrian 710 utilizing visual and/or audible methodologies.

Another application, also related to smart intersections, is shown in FIG. 8. Here, illustrated is a smart intersection 800 that includes cameras 802A-802D having fields of view 804A-804D, respectively. Like before, the cameras 802A-802D are essentially the external devices previously described and collect information regarding the presence and movement of different road users, such as vehicles and pedestrians. Here, the information collected by the cameras 802A-802 may be utilized to determine queues of vehicles, such as the queues 810 and 812. This information can then be utilized by the edge server 100 to adjust a control strategy of a traffic controller, such as the traffic controller 220 illustrated in FIG. 3. By making these adjustments, traffic and flow through the smart intersection 800 more efficiently.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, as indicating the scope hereof.

What is claimed is:

1. An edge server comprising
a processor;
a memory in communication with the processor and having instructions that, when executed by the processor, cause the processor to:
train a model deployed on the edge server using information from one or more external devices received by the edge server;
in response to a determination that the training of the model improved performance of the model, deploy the model;
in response to a request from an aggregation server, transmit one or more model parameters of the model to the aggregation server; and
in response to receiving an updated model from the aggregation server, deploy the updated model, wherein the updated model replaces the model.

2. The edge server of claim 1, wherein the external devices include at least one of:
road user devices;
traffic controllers; and
one or more fixed sensors.

3. The edge server of claim 2, wherein the one or more fixed sensors include at least one of: a camera, a light detection and radar system, a radar, a thermometer, a light sensor, and an infrared camera.

4. The edge server of claim 2, wherein the road user devices include at least one of:
a vehicle system; and
a mobile device.

5. The edge server of claim 1, wherein the model and the updated model generate predicted time series data based on the information from the one or more external devices.

6. The edge server of claim 5, wherein the memory further includes instructions that, when executed by the processor, cause the processor to:
determine a control strategy for a traffic controller based on the predicted time series data; and
control the traffic controller to execute the control strategy.

7. The edge server of claim 5, wherein the memory further includes instructions that, when executed by the processor, cause the processor to:
generate a notification message based on the predicted time series data; and
transmit the notification message to at least one of the one or more external devices.

8. A method executed on an edge server comprising:
training a model deployed on the edge server using information from one or more external devices received by the edge server;
in response to a determination that the training of the model improved performance of the model, deploying the model;
in response to a request from an aggregation server, transmitting one or more model parameters of the model to the aggregation server; and
in response to receiving an updated model from the aggregation server, deploying the updated model, wherein the updated model replaces the model.

9. The method of claim 8, wherein the external devices include at least one of:
road user devices;
traffic controllers; and
one or more fixed sensors.

10. The method of claim 9, wherein the one or more fixed sensors include at least one of: a camera, a light detection and radar system, a radar, a thermometer, a light sensor, and an infrared camera.

11. The method of claim 9, wherein the road user devices include at least one of:
a vehicle system; and
a mobile device.

12. The method of claim 8, wherein the model and the updated model generate predicted time series data based on the information from the one or more external devices.

13. The method of claim 12, further comprising:
determining a control strategy for a traffic controller based on the predicted time series data; and
controlling the traffic controller to execute the control strategy.

14. The method of claim 12, further comprising:
generating a notification message based on the predicted time series data; and
transmitting the notification message to at least one of the one or more external devices.

15. A non-transitory computer-readable medium having instructions that, when executed by a processor, cause the processor to:
train a model deployed on an edge server using information from one or more external devices received by the edge server;
in response to a determination that the training of the model improved performance of the model, deploy the model;
in response to a request from an aggregation server, transmit one or more model parameters of the model to the aggregation server; and
in response to receiving an updated model from the aggregation server, deploy the updated model, wherein the updated model replaces the model.

16. The non-transitory computer-readable medium of claim 15, wherein the external devices include at least one of:
road user devices;
traffic controllers; and
one or more fixed sensors.

17. The non-transitory computer-readable medium of claim 16,
wherein the one or more fixed sensors include at least one of: a camera, a light detection and radar system, a radar, a thermometer, a light sensor, and an infrared camera; and
wherein the road user devices include at least one of: a vehicle system; and a mobile device.

18. The non-transitory computer-readable medium of claim 15, wherein the model and the updated model generate predicted time series data based on the information from the one or more external devices.

19. The non-transitory computer-readable medium of claim 18, further comprising instructions that, when executed by the processor, cause the processor to:
determine a control strategy for a traffic controller based on the predicted time series data; and
control the traffic controller to execute the control strategy.

20. The non-transitory computer-readable medium of claim 18, further comprising instructions that, when executed by the processor, cause the processor to:
generate a notification message based on the predicted time series data; and
transmit the notification message to at least one of the one or more external devices.
